(19) United States
(12) Patent Application Publication
(10) Pub. No.: US 2005/0187685 A1
(43) Pub. Date: Aug. 25, 2005

(54) Occupant restraint system

(75) Inventors: Toshihide Kondo, Aichi-ken (JP); Makoto Aso, Aichi-ken (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/053,896

(22) Filed: Feb. 10, 2005

(30) Foreign Application Priority Data
Feb. 20, 2004 (JP) 2004-44545

(51) Int. Cl. B60R 21/32

(52) U.S. Cl. 701/45; 280/735; 180/282

(57) ABSTRACT

An occupant restraint system of a vehicle has an airbag, a pre-crash sensor which calculates a probability of a collision of a vehicle with an object and outputs a pre-crash signal indicating a prediction of the collision when the probability is higher than a predetermined value, a satellite sensor which detects a degree of acceleration of the vehicle and starts outputting an acceleration signal indicating the detected degree of acceleration in response to the pre-crash signal, and an airbag ECU which processes the acceleration signal to obtain a processing result and deploys the airbag when the processing result indicates a collision of the vehicle with the object. Therefore, because the airbag ECU does not start processing the acceleration signal until the satellite sensor outputs the acceleration signal in response to the pre-crash signal, a load on the airbag ECU can be alleviated.

### CROSS-REFERENCE TO RELATED APPLICATION

This application is based upon and claims the benefit of priority of the prior Japanese Patent Application 2004-44545 filed on Feb. 20, 2004 so that the contents of which are incorporated herein by reference.

### BACKGROUND OF THE INVENTION

1. Field of the Invention

The present invention generally relates to an occupant restraint system in which an occupant restraint device such as an airbag is instantaneously actuated at a vehicle collision time to protect occupants of a vehicle.

2. Description of Related Art

An airbag system of a vehicle has a satellite sensor, an airbag electronic control unit (ECU) and an airbag(s) (see Published Japanese Patent First Publication No. 2002-67870). The satellite sensor is embedded, for example, in a front-end area or a center pillar of the vehicle. The airbag ECU has a G sensor, a central processing unit (CPU) and an igniter. The airbags are embedded in a folded shape, for example, in a central area of a steering wheel, an upper space of a glove box of an instrument panel, side surface areas of seats, and/or both side end areas of a ceiling along a vehicle width.

The CPU of the airbag ECU receives an acceleration signal from the satellite sensor and another acceleration signal from the G sensor, and calculates values of the acceleration signals. When the values are equal to or higher than predetermined threshold values of acceleration, respectively, the CPU judges that the instant vehicle collides with a forward vehicle. Then, the CPU controls the igniter to instantaneously deploy the airbags.

FIG. 5 is a time chart of a communication between a satellite sensor and an airbag ECU, and a current consumed in the communication in a conventional airbag system.

As shown in FIG. 5, when an ignition switch (not shown) is turned on, an airbag system receives electric power, thereby permitting an initial communication between the airbag ECU and the satellite sensor. In the initial communication, information indicating both a part number and an identification code of the satellite sensor is transmitted from the sensor to the airbag ECU. After completion of the initial communication, the satellite sensor invariably outputs an acceleration signal to the airbag ECU. More particularly, the acceleration signal indicating a degree of acceleration or deceleration is periodically transmitted from the satellite sensor to the airbag ECU at a comparatively short communication interval.

As described above, in the conventional airbag system, the acceleration signal is invariably transmitted from the satellite sensor to the airbag ECU after the initial communication. As a result, a problem arises that a large amount of electric power is consumed for the communication between the airbag ECU and the satellite sensor.

Further, after the initial communication, the CPU of the airbag ECU invariably processes arithmetically the acceleration signal transmitted from the satellite sensor. More particularly, the CPU performs a numerical integration for the acceleration signal to obtain an interval-integrated value for a predetermined time interval, and calculates an average value of acceleration from the interval-integrated value. Then, the CPU compares the average value with a predetermined threshold value of acceleration to judge whether or not the instant vehicle collides with a forward vehicle. When the CPU detects a rapid deceleration of the vehicle from a result of the comparison, the airbag ECU judges that the instant vehicle is rapidly decelerated due to the collision with a forward vehicle, thereby controlling the igniter to deploy the airbags.

Therefore, another problem arises that the CPU always bears a heavy load of arithmetically processing the acceleration signal after the initial communication.

Furthermore, the G sensor also invariably transmits an acceleration signal to the airbag ECU after the initial communication with the airbag ECU, in the same manner as the satellite sensor, and the CPU invariably processes arithmetically the acceleration signal. Therefore, a large amount of electric power is consumed for the communication between the airbag ECU and the G sensor, and the CPU always bears a heavy load of arithmetically processing the acceleration signal transmitted from the G sensor.

### SUMMARY OF THE INVENTION

An object of the present invention is to provide, with due consideration of the problems of the conventional airbag system, an occupant restraint system in which electric power consumed in a communication between a sensor generating an acceleration signal and an occupant restraint ECU is reduced, and a load on the occupant restraint ECU is alleviated.

According to a first aspect of this invention, the object is achieved by the provision of an occupant restraint system of a vehicle which comprises an occupant restrainer, a collision predictor which judges whether or not a vehicle is likely to collide with an object, and outputs a pre-crash signal indicating a prediction of a collision of the vehicle with the object when the vehicle is likely to collide with the object, an acceleration detector which detects a degree of acceleration of the vehicle and starts outputting an acceleration signal indicating the detected degree of acceleration in response to the outputting of the pre-crash signal of the collision predictor, and an occupant restraint controller which processes the acceleration signal outputted from the acceleration detector to obtain a processing result, and actuates the occupant restrainer when the processing result indicates the collision of the vehicle with the object.

In the above configuration of the occupant restraint system, in the course of judging that a vehicle is likely to collide with an object, the collision predictor outputs a pre-crash signal. In response to the pre-crash signal, the acceleration detector detecting a degree of acceleration of the vehicle starts outputting an acceleration signal indicating the detected degree of acceleration. When receiving the acceleration signal, the occupant restraint controller processes the acceleration signal to obtain a processing result and actuates the occupant restrainer when the processing result indicates a collision of the vehicle with the object.

Thus, because the acceleration detector does not output the acceleration signal to the occupant restraint controller until the collision predictor predicts the collision of the vehicle with the object, electric power required for the communication between the acceleration detector and the occupant restraint controller can be reduced as compared with a case where the acceleration detector invariably outputs the acceleration signal to the occupant restraint controller regardless of the likelihood of the collision of the vehicle with the object.

Further, because the occupant restraint controller does not start processing the acceleration signal until receiving the acceleration signal from the collision predictor, a processing load on the occupant restraint controller is alleviated as compared with a case where the occupant restraint controller invariably processes the acceleration signal regardless of the likelihood of the collision of the vehicle with the object.

In this invention, the term of “in response to the outputting of the pre-crash signal” denotes both “in response to an instruction outputted from the occupant restraint controller in response to the pre-crash signal received in the occupant restraint controller” and “in response to the pre-crash signal received in the acceleration detector”.

The acceleration detector may output diagnosis information to the occupant restraint controller before the outputting of the pre-crash signal from the collision predictor. By the diagnosis information is meant self-check information on the acceleration detector as to the correctness of its operation.

In this invention, the occupant restraint controller can periodically check conditions of the acceleration detector before processing the acceleration signal.

Preferably, the diagnosis information of the acceleration detector should be periodically outputted to the occupant restraint controller at a first interval of time, a current value of the acceleration signal is periodically outputted from the acceleration detector to the occupant restraint controller at a second interval of time, and the first interval of time is longer than the second interval of time.

In this invention, an electric current consumed in the communication between the acceleration detector and the occupant restraint controller before the outputting of the pre-crash signal can be reduced as compared with that consumed in the transmission of the acceleration signal from the acceleration detector to the occupant restraint controller.

It is preferable that the collision predictor calculate a probability of the collision of the vehicle with the object according to both an inter-vehicle distance between the vehicle and the object and a speed of the vehicle relative to the object, and outputs the pre-crash signal when the probability is higher than a predetermined value.

Therefore, the collision predictor can reliably judge the likelihood of the collision of the vehicle with the object.

The acceleration detector may continue outputting the acceleration signal to the occupant restraint controller after starting the outputting of the acceleration signal, and the occupant restraint controller may continue processing arithmetically the acceleration signal while receiving the acceleration signal.

In this invention, electric power required for the continuous communication between the acceleration detector and the occupant restraint controller can be reduced, and a processing load on the occupant restraint controller is alleviated before receiving the pre-crash signal.

The occupant restraint controller may receive the pre-crash signal from the collision predictor and output an instruction to the acceleration detector in response to the pre-crash signal, and the acceleration detector may start outputting the acceleration signal in response to the instruction of the occupant restraint controller.

Therefore, the occupant restraint controller can reliably start processing the acceleration signal.

The acceleration detector may directly receive the pre-crash signal from the collision predictor and start outputting the acceleration signal in response to the pre-crash signal.

Therefore, the acceleration detector can reliably start outputting the acceleration signal.

Preferably, the pre-crash signal outputted from the collision predictor may act as a trigger for starting outputting the acceleration signal from the collision predictor.

Therefore, a start timing of outputting the acceleration signal can be reliably set.

### BRIEF DESCRIPTION OF THE DRAWINGS

FIG. 1 is a partial top view showing an arrangement of an airbag system of a vehicle according to the first embodiment;

FIG. 2 is a block diagram of the airbag system according to the first embodiment;

FIG. 3 is a flowchart showing an operation of the airbag system shown in FIG. 2 according to the first embodiment;

FIG. 4 is a time chart of a pre-crash signal, a communication with a satellite sensor, and a current consumed in the communication according to the first embodiment; and

FIG. 5 is a time chart of a communication with a satellite sensor, and a current consumed in the communication in a conventional airbag system.

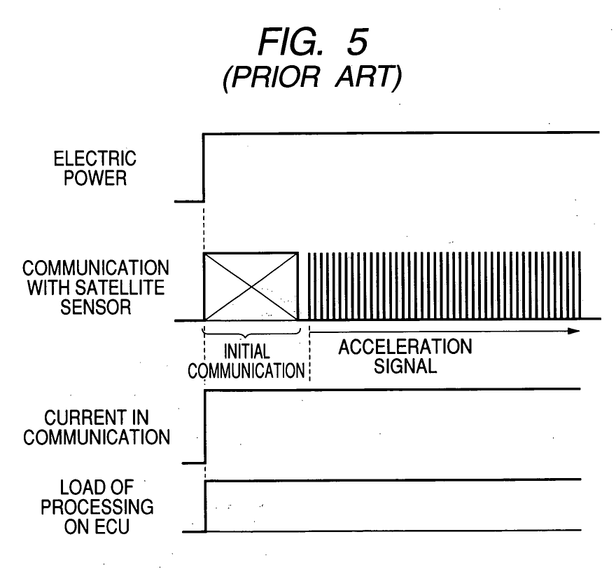

### DETAILED DESCRIPTION OF THE PREFERRED EMBODIMENTS

Embodiments of the present invention will now be described with reference to the accompanying drawings.

### Embodiment 1

In this embodiment, an airbag system representing an occupant restraint system is described.

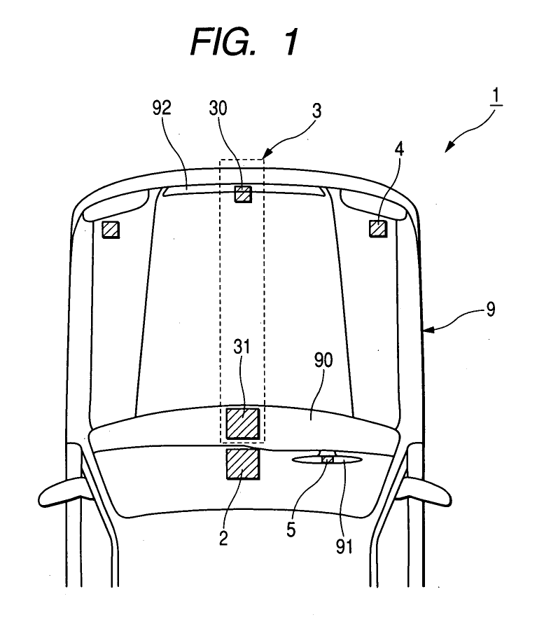

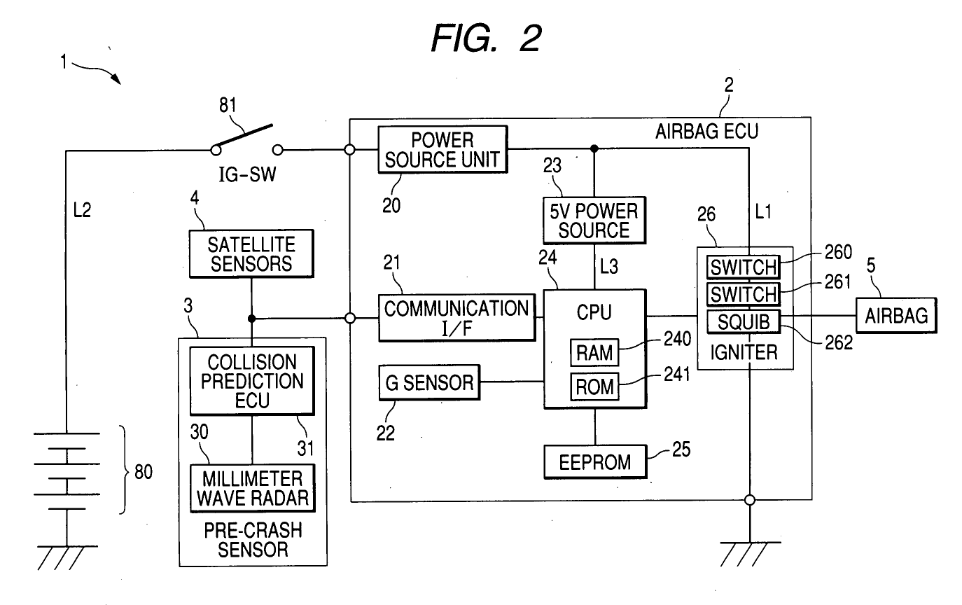

FIG. 1 is a partial top view showing an arrangement of an airbag system disposed on a vehicle according to the first embodiment. FIG. 2 is a block diagram of the airbag system.

As shown in FIG. 1, an airbag system 1 of a vehicle 9 has an airbag ECU (or occupant restraint controller) 2, a pre-crash sensor (or collision predictor) 3, a pair of satellite sensors (or acceleration detectors) 4, and an airbag 5. The airbag system 1 represents an occupant restraint system according to the present invention. The airbag ECU 2 denotes an occupant restraint ECU of the occupant restraint system.

The airbag 5 is embedded in a folded shape into a central area of a steering wheel 91. The airbag 5 denotes an occupant restrainer of the occupant restraint system.

The pre-crash sensor 3 has a millimeter wave radar 30 and a collision prediction ECU 31. The millimeter wave radar 30 is embedded in an area of a rear side of an ornament (not shown) located in the center of a radiator grill 92 of the vehicle 9. The millimeter wave radar 30 radiates millimeter waves in a forward direction of the vehicle 9 and receives the millimeter waves reflected on a forward vehicle (or an object) ahead of the vehicle 9. A period of time from the radiation of the millimeter waves to the reception of the millimeter waves is called a reflection time period in this specification.

The collision prediction ECU 31 is embedded in a front area of an instrument panel 90 located inside (or in a vehicle compartment of) the vehicle 9. The collision prediction ECU 31 calculates, from the reflection time period of the millimeter waves and a change of the reflection time period, both an inter-vehicle distance between the vehicle 9 and the forward vehicle, and a relative speed. The relative speed is defined by subtracting a running speed of the forward vehicle from a running speed of the vehicle 9. The ECU 31 further calculates a prediction value indicating a probability of the collision of the vehicle 9 with the forward vehicle from the calculated inter-vehicle distance and relative speed, and judges according to the prediction value whether or not the vehicle 9 collides with the forward vehicle at high probability. For example, a two-dimensional coordinate system of both an inter-vehicle distance and a relative speed is defined. When coordinate values determined by the calculated distance and relative speed are positioned within a predetermined area in the two-dimensional coordinate system, the ECU 31 judges that the probability of the collision is higher than a predetermined value and predicts the collision of the vehicle 9 with the forward vehicle. When the collision prediction ECU 31 predicts the collision, the collision prediction ECU 31 outputs a pre-crash signal to the airbag ECU 2 to start a collision prediction period of time in the airbag ECU 2. When the ECU 31 judges that the probability of the collision becomes lower than a second predetermined value after the outputting of the pre-crash signal, the ECU 31 outputs a non-crash signal to the airbag ECU 2 to cancel the prediction of the collision. Therefore, the collision prediction period of time is ended.

The satellite sensors 4 are, respectively, disposed at right and left ends in a head portion of the vehicle 9. Each satellite sensor 4 usually outputs diagnosis information or self-check information to the airbag ECU 2. The information indicates, for example, conditions of the satellite sensor 4 as to the correctness in its operation, so that the airbag ECU 2 can detect whether or not the satellite sensor 4 is correctly operated. Further, the satellite sensor 4 electrically detects a degree of acceleration (or deceleration) of the vehicle 9, and outputs a first acceleration signal indicating the degree of acceleration to the airbag ECU 2 during the collision prediction period of time.

The airbag ECU 2 is embedded in a space positioned under the instrument panel 90.

As shown in FIG. 2, the airbag ECU 2 has a power source unit 20 connected to a battery 80 of 12V through an ignition switch 81, a 5V power source 23 connected to the power source unit 20, a communication interface (I/F) 21 connected to both the collision prediction ECU 31 of the pre-crash sensor 3 and the satellite sensors 4, a CPU 24 connected to the communication I/F 21 and the 5V power source 23, a G sensor (or another acceleration detector) 22 connected to the CPU 24, an electrically erasable and programmable read only memory (EEPROM) 25 connected to the CPU 24, and an igniter 26 connected to the power source unit 20 through a source line L1, the CPU 24 and the airbag 5.

The communication I/F 21 allows the airbag ECU 2 to perform a two-way communication with the collision prediction ECU 31 and the satellite sensors 4.

The G sensor 22 usually outputs diagnosis information (or self-check information) to the airbag ECU 2, so that the airbag ECU 2 can detect whether or not the G sensor 22 is correctly operated. Further, the G sensor 22 electrically detects a degree of acceleration (or deceleration) of the vehicle 9, and outputs a second acceleration signal indicating the degree of acceleration to the CPU 24 during the collision prediction period of time.

The 5V power source 23 transforms a battery voltage of 12V applied from the power source unit 20 into 5V and supplies a source voltage of 5V to the CPU 24. The EEPROM 25 is made of a non-volatile memory having an electrically rewritable function and stores the diagnosis information outputted from the satellite sensors 4 and the G sensor 22.

The CPU 24 has a random access memory (RAM) 240 and a read only memory (ROM) 241. The RAM 240 temporarily stores the acceleration signals from the satellite sensors 4 and the G sensor 22. The ROM 241 stores a first threshold value Th1 of acceleration for the first acceleration signals of the satellite sensors 4, a second threshold value Th2 of acceleration for the second acceleration signal of the G sensor 22 and an acceleration estimating program. This program is used to calculate an average value of acceleration from pulses of each acceleration signal.

The igniter 26 has a squib 262 and two switches 260 and 261 arranged in series between the source line L1 and the ground.

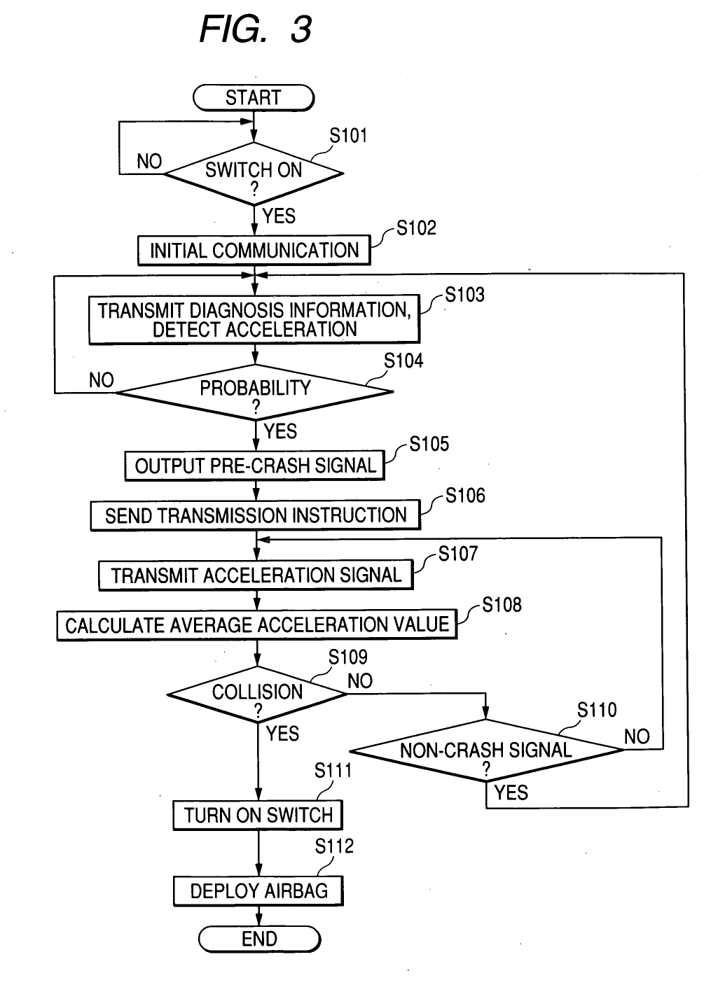

Next, an operation of the airbag system 1 is described with reference to FIG. 3. FIG. 3 is a flow chart showing an operation of the airbag system 1 according to this embodiment.

When the ignition switch 81 is turned on (YES at step S101), a battery voltage of 12V is applied from the battery 80 to the power source unit 20 through a source line L2. The battery voltage is transformed into 5V in the 5V source 23, and the voltage of 5V is applied to the CPU 24 through a source line L3. Further, the voltage of 5V is applied to the units 3, 4, 21, 22 and 25, and the battery voltage of 12V is applied to the switch 260 of the igniter 26. Each of the switches 260 and 261 is initially set at an off state not to apply the battery voltage of 12V to the squib 262. Therefore, the airbag system 1 is set at an operation mode.

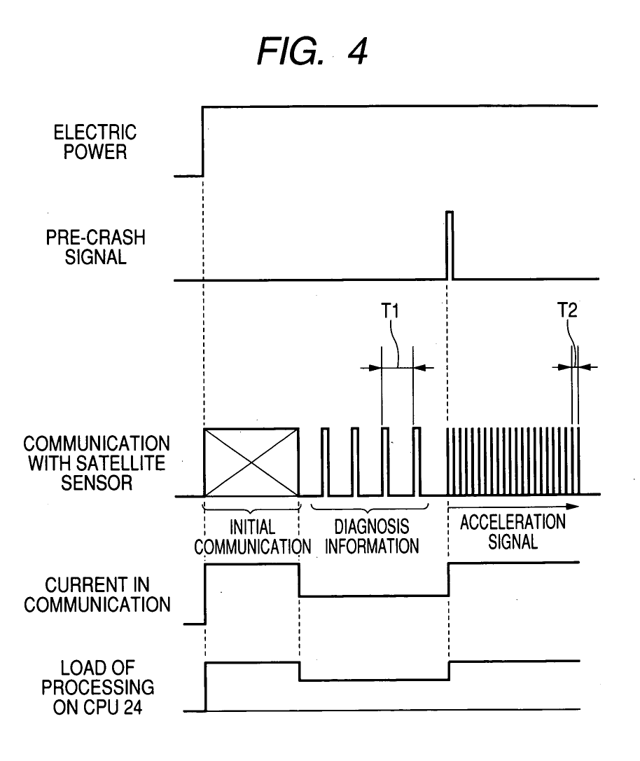

FIG. 4 is a time chart of a pre-crash signal, a communication between each of the satellite sensors 4 and the CPU 24, and a current consumed in the communication according to this embodiment.

As shown in FIG. 4, when the airbag system 1 is set at the operation mode, an initial communication is performed between each satellite sensor 4 and the CPU 24 through the communication I/F 21 (step S102). More particularly, both a part number and an identification code of the satellite sensor 4 are transmitted from the satellite sensor 4 to the CPU 24. This initial communication is also performed between the G sensor 22 and the CPU 24 (step S102). The initial communication is continued, for example, for about 3 seconds.

After the initial communication, diagnosis information indicated, for example, by a pulse is transmitted from the satellite sensor 4 to the CPU 24 every first communication interval of time T1 (step S103). The time interval T1 is set, for example, at 25 ms. Diagnosis information is also transmitted from the G sensor 22 to the CPU 24 in the same manner as that of the satellite sensor 4 (step S103). Further, each of the sensors 4 and 22 detects a degree of acceleration of a vehicle 9 (step S103).

Thereafter, the collision prediction ECU 31 of the pre-crash sensor 3 judges whether or not the vehicle 9 is likely to collide with an object such as a forward vehicle. More particularly, the collision prediction ECU 31 calculates both an inter-vehicle distance between the instant vehicle 9 and a forward vehicle and a relative speed between the instant vehicle 9 and the forward vehicle every predetermined interval of time, and calculates a probability of a collision of the vehicle 9 with the forward vehicle from both the inter-vehicle distance and the relative speed. Then, the ECU 31 judges whether or not the probability of the collision is higher than a predetermined value (step S104).

When the probability of the collision is equal to or lower than the predetermined value (NO at step S104), the ECU 31 judges that the ECU 31 does not require an acceleration signal from any of the sensors 4 and 22. In this case, each of the sensors 4 and 22 continues transmitting the diagnosis information at step S103. Therefore, the diagnosis information is periodically (or repeatedly) outputted from each of the sensors 4 and 22 to the CPU 24 at the time interval T1.

In contrast, when the probability of the collision becomes higher than the predetermined value (YES at step S104), the collision prediction ECU 31 predicts that the vehicle 9 collides with the forward vehicle at high probability. For example, when the inter-vehicle distance is suddenly shortened due to a rapid change of the relative speed, the probability of the collision becomes higher than the predetermined value.

If YES at step S104 is satisfied, the ECU 31 outputs a pre-crash signal indicating a prediction of the collision to the CPU 24 through the communication I/F 21 (step S105), and the CPU 24 receives the pre-crash signal. The pre-crash signal is, for example, a one-pulse signal.

In response to the pre-crash signal, the CPU 24 sends an acceleration transmission instruction to the satellite sensors 4 and the G sensor 22 to urge each of the sensors 4 and 22 to output an acceleration signal (step S106) to the CPU 24, and the CPU 24 prepares to receive acceleration signals from the sensors 4 and 22.

In response to the acceleration transmission instruction, each satellite sensor 4 starts transmitting a first acceleration signal indicating a current value of acceleration of the vehicle 9 to the CPU 24 through the communication I/F 21 every second communication interval of time T2 (step S107). Therefore, because the pre-crash signal acts as a trigger for starting outputting the first acceleration signal from the satellite sensor 4, the satellite sensor 4 starts outputting the first acceleration signal to the CPU 24 in response to the outputting of the pre-crash signal from the ECU 31.

The acceleration signal has a single pulse. A positive-valued pulse of the acceleration signal indicates deceleration of the vehicle 9, and a negative-valued pulse indicates acceleration of the vehicle 9. An absolute pulse height is increased with a degree of acceleration or deceleration. The time interval T2 is considerably shorter than the time interval T1 of the diagnosis information and is set, for example, at 250 μs.

Each first acceleration signal is temporarily stored in the RAM 240 and is read out from the RAM 240. Then, the CPU 24 starts performing an interval-integration of the first acceleration signals by using the acceleration estimating program of the ROM 241 to obtain an interval-integrated value, and calculates an average value M1 of acceleration for a predetermined time interval from the interval-integrated value every time interval T2 (step S108). A positive value M1 indicates a degree of deceleration of the vehicle 9. The CPU 24 compares the average value M1 with a first threshold value Th1 of acceleration stored in the ROM 241 and judges whether or not the vehicle 9 collides with the forward vehicle (step S109).

When the relation M1<Th1 is satisfied for the first acceleration signals of the satellite sensors 4 (that is, an average degree of deceleration of the vehicle 9 is lower than the value Th1), the CPU 24 judges that the vehicle 9 does not yet collide with the forward vehicle (NO at step S109). Thereafter, the CPU 24 judges whether or not the CPU 24 receives a non-crash signal (step S110). When the CPU 24 receives a non-crash signal from the ECU 31 after receiving the pre-crash signal (YES at step S110), each of the satellite sensors 4 stops transmitting the first acceleration signal to the CPU 24 and starts transmitting diagnosis information to the CPU 24. The non-crash signal indicates the cancellation of the prediction of the collision. In contrast, when the CPU 24 does not receive any non-crash signal from the ECU 31, each of the satellite sensors 4 continues transmitting the first acceleration signal to the CPU 24. Therefore, a current value of the first acceleration signal is periodically (or repeatedly) outputted from each of the satellite sensors 4 to the CPU 24 at the time interval T2.

In contrast, when the relation M1≧Th1 is satisfied for at least one first acceleration signal (that is, an average degree of deceleration of the vehicle 9 is equal to or higher than the value Th1), the CPU 24 judges that the first acceleration signal indicates that the vehicle 9 has just collided with the forward vehicle (YES at step S109). In this case, the CPU 24 outputs a safing driving signal to the igniter 26 to protect an occupant of the vehicle 9 from an impact of the collision. In response to the safing driving signal, the switch 260 of the igniter 26 is turned on (step S111).

Further, in response to the acceleration transmission instruction from the CPU 24, the G sensor 22 starts transmitting a second acceleration signal of one pulse to the CPU 24 every third communication interval of time T3 shorter than the time interval T1 of the diagnosis information (step S107), and the CPU 24 starts processing the second acceleration signal in the same manner as the processing of the first acceleration signal (step S108). The time interval T3 is set, for example, at 250 μs.

More particularly, the CPU 24 calculates a second average value M2 of acceleration from the second acceleration signal, and compares the average value M2 with a second threshold value Th2 of acceleration stored in the ROM 241. When the relation M2≧Th2 is satisfied, the CPU 24 judges that the second acceleration signal indicates that the vehicle 9 has just collided with the forward vehicle (step S109). Then, the CPU 24 outputs a main driving signal to the switch 261 of the igniter 26, and the switch 261 is turned on in response to the main driving signal (step S111).

Therefore, when both the switches 260 and 261 are turned on, the voltage of 12V is applied to the squib 262 of the igniter 26 through the electric line L1 and the switches 260 and 261 turned on, and the squib 262 is instantaneously heated. An inflator (not shown) generates a nitrogen gas in response to the heating of the squib 262, and the nitrogen gas rapidly deploys the airbag 5 folded in the inside of the vehicle 9 (step S112). As a result, the deployed airbag 5 protects the occupant of the vehicle 9 from an impact of the collision of the vehicle 9 with the forward vehicle.

During the processing shown in FIG. 3, the airbag ECU 2 always checks whether or not the ignition switch 81 is turned off. When the ignition switch 81 is set at an off state, this processing is ended.

Next, effects of this embodiment are described below.

In the airbag system 1 according to this embodiment, none of the satellite sensors 4 and the G sensor 22 start outputting acceleration signals to the airbag ECU 2 until the collision prediction ECU 31 outputs a pre-crash signal to the airbag ECU 2. Accordingly, electric power consumed for the communication between each of the sensors 4 and 22 and the airbag ECU 2 can be reduced.

Further, the airbag ECU 2 does not receive any acceleration signal until the reception of a pre-crash signal. Therefore, the CPU 24 does not process arithmetically the acceleration signal until receiving a pre-crash signal. Accordingly, an electric power required for the arithmetic processing in the CPU 24 can be reduced.

Moreover, because the diagnosis information is periodically transmitted from the satellite sensors 4 and the G sensor 22 to the airbag ECU 2 before the transmission of a pre-crash signal to the airbag ECU 2, conditions of the satellite sensors 4 and the G sensor 22 can be periodically checked in the CPU 24. Further, the acceleration signal is periodically transmitted from each of the sensors 4 and 22 to the airbag ECU 2 after the transmission of a pre-crash signal to the airbag ECU 2. Therefore, the airbag system 1 can detect the collision of the vehicle with an object by processing arithmetically the acceleration signals in the CPU 24. Accordingly, the airbag system 1 can protect an occupant(s) of the vehicle 9 from an impact on collision.

Furthermore, in the airbag system 1 according to this embodiment, the time interval T1 for the transmission of the diagnosis information is longer than the time intervals T2 and T3 for the transmission of the acceleration signals (see FIG. 4). Accordingly, an electric current consumed during the transmission of the diagnosis information can be lower than that consumed during the transmission of the acceleration signals.

Still further, none of the satellite sensors 4 and the G sensor 22 start outputting acceleration signals to the airbag ECU 2 until the collision prediction ECU 31 judges that there is a high probability of the instant vehicle 9 colliding with a forward vehicle. In other words, the sensors 4 and 22 output the acceleration signals only during a minimum period of time required for the detection of the collision. Accordingly, electric power for the transmission of the acceleration signals can be considerably reduced.

Still further, because the airbag ECU 2 receives the acceleration signals only during the minimum period of time, the airbag ECU 2 can be prevented at the greatest possibility from erroneously deploying the airbag 5.

In this embodiment, the airbag system 1 is described as an example of the occupant restraint system. However, the airbag system 1 should not be construed as limiting to the present invention. Various modifications of the airbag system 1 performed by any person of ordinary skill in this art should be included in the present invention.

For example, in this embodiment, a pre-crash signal is transmitted from the collision prediction ECU 31 to the airbag ECU 2 to urge the CPU 24 to transmit an instruction to each of the satellite sensors 4 and the G sensor 22. However, a pre-crash signal may be transmitted from the collision prediction ECU 31 to each of the satellite sensors 4 and the G sensor 22. In this case, each of the satellite sensor 4 and the G sensor 22 outputs an acceleration signal to the CPU 24 in response to the received pre-crash signal, and the CPU 24 automatically starts calculating average values M1 and M2 of acceleration in response to the reception of the acceleration signals.

In this specification, the term of “in response to the outputting of the pre-crash signal” denotes both “in response to the acceleration transmission instruction outputted from the CPU 24 in response to the pre-crash signal” and “in response to the pre-crash signal received in each of the sensors 4 and 22”.

Further, in this embodiment, a plurality of sensors such as the satellite sensors 4 and the G sensor 22 are used in the airbag system 1 to reliably and accurately detect a degree of acceleration of the vehicle 9. However, the combination of sensors should not be construed as limiting to the present invention. For example, the combination of one satellite sensor and one G sensor, the combination of two G sensors or the combination of two satellite sensors may be used, or only one of the satellite sensors 4 and the G sensor 22 may be used.

Moreover, the pre-crash sensor 3 is realized by the combination of the millimeter-wave radar 30 and the collision prediction ECU 31. However, a millimeter-wave radar with a microcomputer for collision prediction may be used as the pre-crash sensor 3 without using the collision prediction ECU 31. In this case, a pre-crash signal is transmitted from the millimeter-wave radar to the airbag ECU 2 or the sensors 4 and 22.

Furthermore, in this embodiment, the collision prediction ECU 31 predicts the collision on the basis of both an inter-vehicle distance and a relative speed. However, the collision prediction ECU 31 may predict the collision on the basis of an oil pressure of a brake master cylinder and/or the lightning of a stop lamp.

Furthermore, in this embodiment, the occupant restraint system according to the present invention is realized by the airbag system 1. However, the occupant restraint system maybe realized by a seat belt pretensioner system. In this case, when a CPU of the seat belt pretensioner system receives a pre-crash signal from the ECU 31, a seat belt is tightened to fix an occupant to his or her seat at a first force. When the CPU judges according to the acceleration signals that the vehicle collides with an object, the seat belt is further tightened to fix the occupant to the seat at a maximum force.

Still further, in this embodiment, the detection of a degree of acceleration of the vehicle 9 in each of the sensors 4 and 22 is performed at step 103. However, each of the sensors 4 and 22 may start detecting a degree of acceleration when receiving a pre-crash signal from the ECU 31 or receiving a signal transmission instruction from the CPU 24.

Still further, in this embodiment, two switches 260 and 261 corresponding to the first and second acceleration signals are disposed in the igniter 26. However, only one switch may be disposed in the igniter 26. In this case, when the CPU 24 judges according to each of the first and second acceleration signals that a vehicle collide with an object, the CPU 24 outputs only one driving signal to the igniter 26, and the switch is turned on in response to the driving signal.

Still further, in this embodiment, the collision prediction ECU 31 predicts the collision with a forward vehicle. However, the collision prediction ECU 31 may predict the collision with an object approaching from any direction of the instant vehicle 9. For example, the collision prediction ECU 31 may predict the collision with a rock or a big animal approaching from a side direction of the instant vehicle 9.

Still further, in this embodiment, the outputting of a non-crash signal from the ECU 31 may be prohibited for a predetermined period of time (for example, 10 seconds) after the outputting of a pre-crash signal from the ECU 31.

1. An occupant restraint system comprising:
an occupant restrainer;
a collision predictor which judges whether or not a vehicle is likely to collide with an object, and outputs a pre-crash signal indicating a prediction of a collision of the vehicle with the object when the vehicle is likely to collide with the object;
an acceleration detector which detects a degree of acceleration of the vehicle and starts outputting an acceleration signal indicating the detected degree of acceleration in response to the outputting of the pre-crash signal from the collision predictor; and
an occupant restraint controller which processes the acceleration signal outputted from the acceleration detector to obtain a processing result, and actuates the occupant restrainer when the processing result indicates a collision of the vehicle with the object.

2. The occupant restraint system according to claim 1, wherein the acceleration detector outputs diagnosis information indicating conditions of the acceleration detector to the occupant restraint controller before the outputting of the pre-crash signal from the collision predictor.

3. The occupant restraint system according to claim 2, wherein the diagnosis information of the acceleration detector is periodically outputted to the occupant restraint controller at a first interval of time, a current value of the acceleration signal is periodically outputted from the acceleration detector to the occupant restraint controller at a second interval of time, and the first interval of time is longer than the second interval of time.

4. The occupant restraint system according to claim 1, wherein the collision predictor calculates a probability of the collision of the vehicle with the object according to an inter-vehicle distance between the vehicle and the object and a speed of the vehicle relative to the object, and outputs the pre-crash signal when the probability is higher than a predetermined value.

5. The occupant restraint system according to claim 1, wherein the acceleration detector continues outputting a current value of the acceleration signal to the occupant restraint controller after starting the outputting of the acceleration signal, and the occupant restraint controller continues processing arithmetically the acceleration signal while receiving the acceleration signal.

6. The occupant restraint system according to claim 1, wherein the acceleration detector is a satellite sensor disposed outside the occupant restraint controller.

7. The occupant restraint system according to claim 1, wherein the acceleration detector is a G sensor disposed inside the occupant restraint controller.

8. The occupant restraint system according to claim 1, wherein the occupant restraint controller receives the pre-crash signal from the collision predictor and outputs an instruction to the acceleration detector in response to the pre-crash signal, and the acceleration detector starts outputting the acceleration signal in response to the instruction of the occupant restraint controller.

9. The occupant restraint system according to claim 1, wherein the acceleration detector receives the pre-crash signal from the collision predictor and starts outputting the acceleration signal in response to the pre-crash signal.

10. The occupant restraint system according to claim 1, wherein the pre-crash signal outputted from the collision predictor acts as a trigger for starting outputting the acceleration signal from the collision predictor.
